(19) United States
(12) Patent Application Publication
(10) Pub. No.: US 2016/0042712 A1
(43) Pub. Date: Feb. 11, 2016

(54) A DISPLAY CONTROL UNIT AND A DISPLAY DEVICE

(71) Applicants: BOE TECHNOLOGY GROUP CO., LTD., Beijing (CN); BEIJING BOE DISPLAY TECHNOLOGY CO., LTD., Beijing (CN)

(72) Inventors: Dan Su, Beijing (CN); Wenhai Cui, Beijing (CN)

(21) Appl. No.: 14/429,832

(22) PCT Filed: Jun. 23, 2014
(86) PCT No.: PCT/CN2014/080506

§ 371 Date: Mar. 20, 2015

(30) Foreign Application Priority Data
Jan. 28, 2014 (CN) 201410042285.5

(51) Int. Cl. G09G 3/36

(52) U.S. Cl. CPC G09G 3/3696; G09G 3/3648; G09G 2330/027; G09G 2330/021; G09G 2300/0426

(57) ABSTRACT

The present invention provides for a display control unit and a display device, and relates to the field of display technology; specifically, reducing the current flowing through an Anisotropic Conductive Film during a process of eliminating shutdown afterimage of the display device. The display control unit includes a GOA gate driving module integrated on a display panel, a control module, and a voltage reducing module. The voltage reducing module can reduce a pulse current generated by an off-voltage when the control module outputs the off-voltage to eliminate the shutdown afterimage.

### RELATED APPLICATIONS

This application is the U.S. national stage entry of PCT/CN2014/080506 with an international filing date of Jun. 23, 2014, which claims priority to and any other benefit of Chinese Application No. 201410042285.5 filed Jan. 28, 2014 and entitled “A display control unit and a display device,” the entire disclosures of which are incorporated by reference herein.

### FIELD

The present invention relates to the field of display technology, particularly to a display control unit and a display device.

### BACKGROUND

Generally, in the manufacturing of the Thin Film Transistor Liquid Crystal Displays (TFT-LCDs), a Gate Driver on Array (GOA) circuit may be used to integrate the circuit that controls on and off of gates of TFTs utilizing the array substrate of the display panel to form scan driving to the display panel. This configuration saves the bonding area of the gate driving circuit and the peripheral wiring space. Specifically, as shown in FIG. 1, the display device may comprise a timing controller 100, a source driver 102, and a GOA unit 101 integrated on a display panel 103. The GOA unit 101 controls signal output of the gate lines (G1 . . . Gn) and the source driver 102 controls signal output of the data lines (S1 . . . Sn). The timing controller 100 inputs a control signal and an image data signal to the GOA unit 101 and the source driver 102 respectively. The GOA unit 101 then turns on the thin film transistors connected on each scanning line in turn, row by row, to enable the display panel 103 to display different images. However, the liquid crystal capacitor CLC and the storage capacitor CS of the above display panel 103 may accumulate charges due to the charging when the display panel works. When the display panel 103 turns off the power supply, display images may be left on the display panel because these charges cannot be released effectively, thereby resulting in generation of afterimage.

In order to solve the afterimage problem, the GOA unit 101 generally turns on all rows of the gate lines of the display panel 103 at the instant of shutdown. The display panel 103 receives an off-voltage VOFF, and controls the off-voltage VOFF through the GOA unit 101 to charge gates of all rows, such that all of the TFTs are turned on. Thus, the charges accumulated on the liquid crystal capacitor CLC and the storage capacitor CS can be released, thereby eliminating the afterimage phenomenon. An Anisotropic Conductive Film (ACF) is generally used to press the circuit that controls the display panel 103 with the display panel 103, and the ACF has particles that can come into contact with one another and have conductive capacity. However, when the off-voltage VOFF is relatively high, the current flowing through the ACF is also relatively large. When the current exceeds the bearing capacity of the ACF particles, the particles may be fused, thereby the TFT cannot be turned on, and the afterimage cannot be eliminated.

In order to solve the above problem, the material of the ACF or the fabricating process thereof is generally improved in the prior art so as to increase tolerance of the above thin film layer to a relatively large current. However, from the perspective of panel design, the cost of the above improving method is very high, thus the production cost will be increased.

### SUMMARY OF THE INVENTION

Embodiments of the present invention provide for a display control unit and a display device that reduces the current flowing through an Anisotropic Conductive Film during the process of eliminating shutdown afterimage of the display device.

In order to achieve the above objective, embodiments of the present invention adopt the following technical solutions:

In one aspect, a display control unit comprising a GOA gate driving module integrated on a display panel is provided, comprising: a control module and a voltage reducing module. The control module is connected to a first voltage input terminal and the voltage reducing module respectively, for outputting an off-voltage to the display panel integrated with the GOA gate driving module based on a voltage of the first voltage input terminal, so as to charge at least one row of gate lines of the display panel under the control of the GOA gate driving module. The voltage reducing module is connected to the control module and the GOA gate driving module respectively, for reducing the off-voltage.

In another aspect, a display device is provided and includes a display control unit as stated above.

In yet another aspect, a display control unit and a display device is provided. The display control unit includes a GOA gate driving module integrated on a display panel, and further includes a control module and a voltage reducing module. The voltage reducing module can reduce the pulse current generated by the off-voltage when the control module outputs the off-voltage so as to eliminate the shutdown afterimage. Thus, the current flowing through the Anisotropic Conductive Film can be reduced during the process of eliminating shutdown afterimage of the display device, thereby avoiding the conductive particles of the Anisotropic Conductive Film from being burnt by a relatively large current flowing through the ACF so as to eliminate the afterimage.

### BRIEF DESCRIPTION OF DRAWINGS

FIG. 1 is a structural schematic view of a TFT liquid crystal display provided by the prior art.

FIG. 2 is a structural schematic view of a display device provided by an embodiment of the present invention.

FIG. 3 is a structural schematic view of a display control unit provided by an embodiment of the present invention.

FIG. 4 is a structural schematic view of another display control unit provided by an embodiment of the present invention.

FIG. 5 a structural schematic view of another display control unit provided by an embodiment of the present invention.

FIG. 6 is a structural schematic view of another display device provided by an embodiment of the present invention.

### DETAILED DESCRIPTION OF THE INVENTION

The present invention will be described in more detail in combination with the drawings and embodiments of the present invention provided herein. The following described embodiments are used for explanation of the present invention and are not provided for limitation of the scope of the present invention. Thus, a person having ordinary skill in the art may conceive of other embodiments within the scope of protection of the present invention.

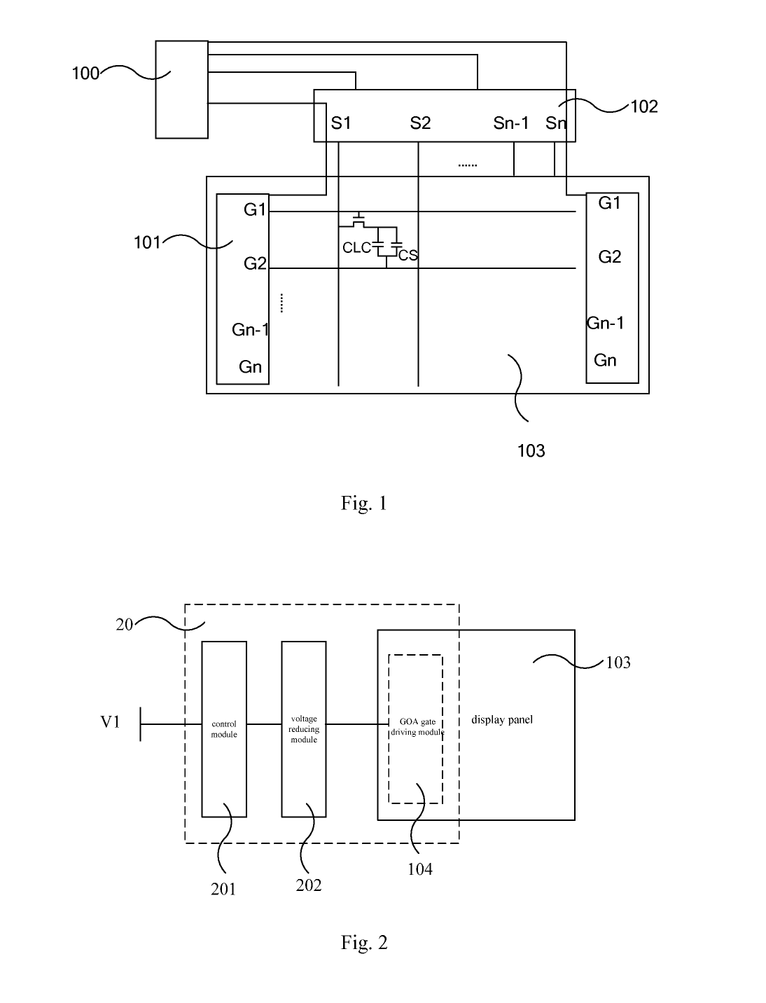

Referring to FIG. 2, an embodiment of the present invention is provided and includes a GOA gate driving module 104 integrated on a display panel 103. This configuration allows the bonding area of the gate driving circuit and the peripheral wiring space to be saved, thereby reducing the cost of manufacturing the display panel. The display control unit 20 further includes a control module 201 and a voltage reducing module 202.

The control module 201 is connected to a first voltage input terminal and the voltage reducing module 202 respectively. Outputting an off-voltage to the display panel 103 integrated with the GOA gate driving module 104, based on a voltage V1 of the first voltage input terminal, charges at least one row of gate lines of the display panel 103 under the control of the GOA gate driving module 104.

Specifically, the control module 201 determines a working state of the display panel 103 based on the voltage V1 of the first voltage input terminal. When the control module 201 determines that the display panel 103 is in a shutdown state, rows of gate lines of the display panel 103 are turned on under the control of the GOA gate driving module 104, so as to enable the control module 201 to output an off-voltage VOFF to the display panel 103. The gates in rows of the display panel 103 are charged by the off-voltage VOFF, so as to enable all the TFTs to be turned on, and the charges accumulated on the liquid crystal capacitor CLC and the storage capacitor CS are released so as to eliminate the afterimage.

The voltage reducing module 202 is connected to the control module 201 and the GOA gate driving module 104 respectively, for reducing the off-voltage VOFF.

In one embodiment, a display control unit includes a GOA gate driving module integrated on a display panel. The display control unit includes a control module and a voltage reducing module. The voltage reducing module can reduce a pulse current generated by the off-voltage when the control module outputs the off-voltage to eliminate the shutdown afterimage. Thus, the current flowing through the Anisotropic Conductive Film can be reduced during the process of eliminating shutdown afterimage of the display device, thereby avoiding the conductive particles of the Anisotropic Conductive Film from being burnt by a relatively large current flowing through the Anisotropic Conductive Film so as to eliminate the afterimage.

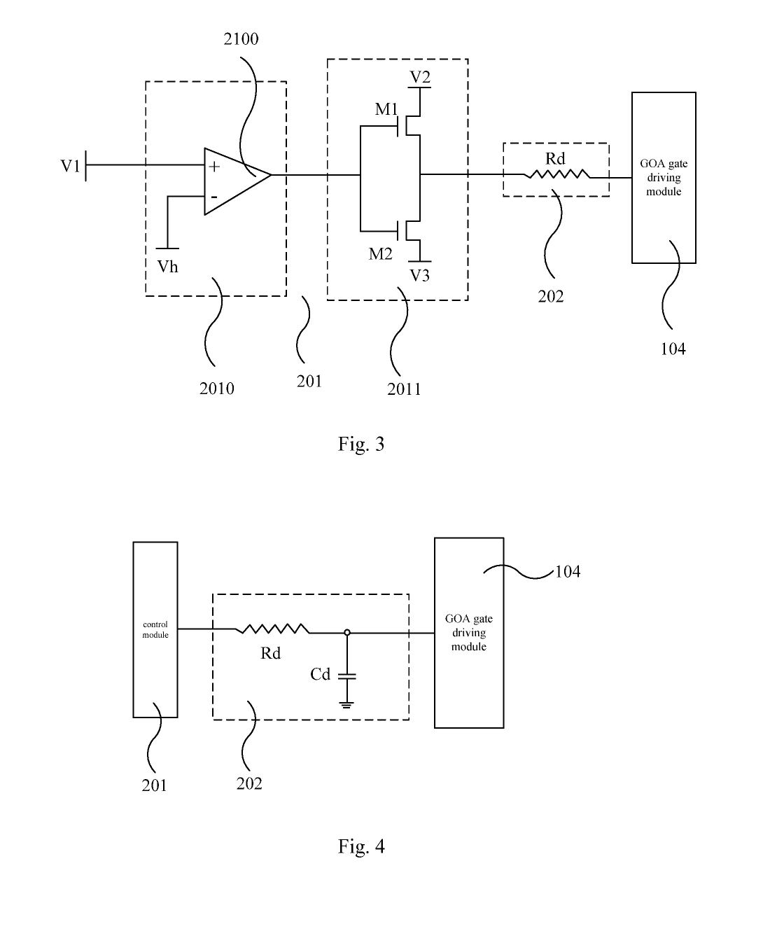

As shown in FIG. 3, the voltage reducing module 202 may include a voltage reducing resistor Rd, an input terminal of the voltage reducing resistor Rd being connected to the control module 201, and an output terminal thereof being connected to the GOA gate driving module 104. Thus, the voltage reducing resistor Rd can limit the magnitude of the pulse current IOFF generated by the off-voltage VOFF output by the control module 201, thereby avoiding the pulse current IOFF from burning the particles of the Anisotropic Conductive Film that connects the display control unit 20 to the display panel 103 integrated with the GOA gate driving module 104 due to the excessive off-voltage VOFF.

The resistance of the voltage reducing resistor Rd may be between approximately 20Ω and 130Ω. When the resistance of the voltage reducing resistor Rd is too small, for example, less than 20Ω, its current limiting effect is relatively weak and the pulse current IOFF generated by the off-voltage VOFF output by the control module 201 cannot be reduced. When the resistance of the voltage reducing resistor Rd is too large, for example, larger than 130Ω, its current limiting effect is too strong and the pulse current IOFF generated by the off-voltage VOFF output by the control module 201 may be too small to charge the gates in rows when the GOA gate driving module 104 turns on the gates in rows. Thus, the TFT cannot be turned on and the process of eliminating the afterimage may fail.

For example, the resistance of the voltage reducing resistor Rd may be selected as 75Ω. In this example, the peak to peak (PK-PK) value of the pulse current IOFF generated by the off-voltage VOFF is 350 mA. Without the voltage reducing module 202, in this embodiment, the peak to peak (PK-PK) value of the pulse current IOFF generated by the off-voltage output by the control module 201 thereof may be larger than 1.1A. Therefore, the voltage reducing resistor Rd with the resistance of achieves the result of adequately reducing the pulse current IOFF.

According to another embodiment of the present invention, as shown in FIG. 4, the voltage reducing module 202 may include a voltage reducing capacitor Cd, with an input terminal of the voltage reducing capacitor Cd connected to the output terminal of the voltage reducing resistor Rd, and an output terminal thereof connected to ground. Thus, on the basis that the voltage reducing resistor Rd performs current limiting to the pulse current IOFF generated by the off-voltage VOFF, part of the charges may also be stored by the voltage reducing capacitor Cd. The voltage reducing capacitor Cd weakens the pulse current IOFF to avoid the generated current from burning the particles of the Anisotropic Conductive Film that connects the display control unit 20 to the display panel 103 integrated with the GOA gate driving module 104 when the off-voltage VOFF is too large.

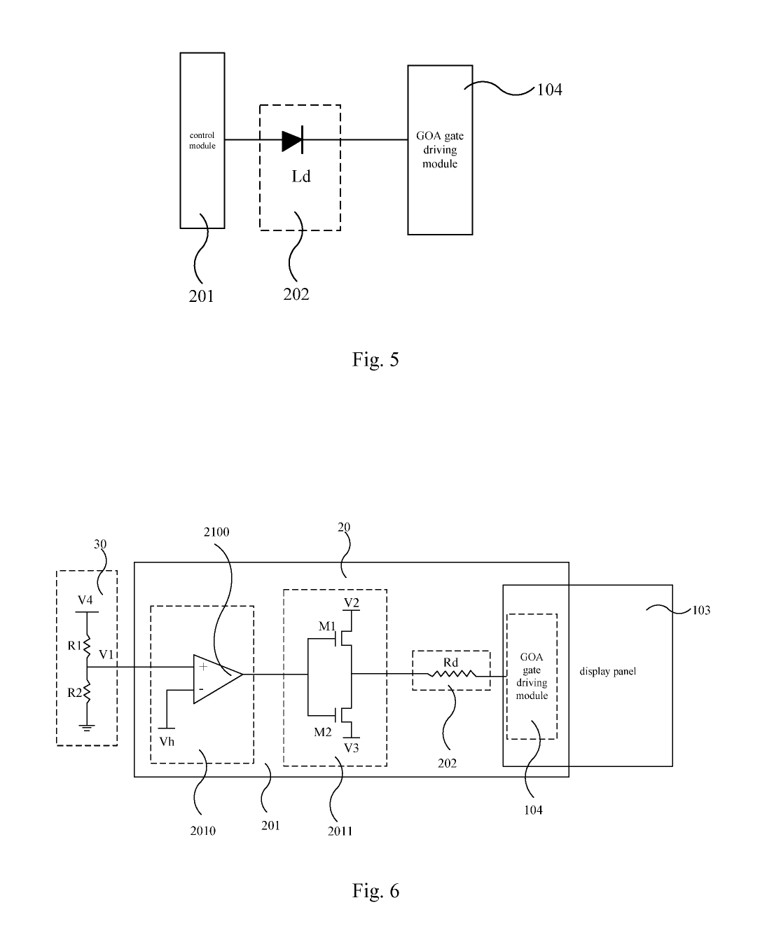

In some embodiments, as shown in FIG. 5, the voltage reducing module 202 includes a voltage reducing diode Ld. An input terminal of the voltage reducing diode Ld is connected to the control module 201 and an output terminal is connected to the GOA gate driving module 104. By arranging the voltage reducing diode Ld as illustrated, the pulse current IOFF generated by the off-voltage VOFF can be consumed, thereby achieving the aim of reducing the pulse current IOFF.

The above embodiments of the voltage reducing module 202 are provided only for illustration purposes. Voltage reducing modules constituted by other electrical components will not be illustrated here one by one; however, they all should belong to the protection scope of the present invention.

Again referring to FIG. 3, the control module 201 may include a comparison sub-module 2010 and a conversion sub-module 2011. The comparison sub-module 2010 is connected to the first voltage input terminal and to the conversion sub-module 2011, and compares a voltage V1 of the first voltage input terminal with a preset voltage Vf.

It should be noted that the preset voltage Vf can be set according to different display devices. Since V1 of the first voltage input terminal is related to the supply voltage of the display device, the control module 201 can determine the display state of the display panel 103 based on the comparison result of the voltage V1 of the first voltage input terminal and the preset voltage Vf. For example, when the voltage V1 of the first voltage input terminal is larger than the preset voltage Vf, the control module 201 may determine that the display panel 103 is in a working state. When the voltage V1 of the first voltage input terminal is smaller than the preset voltage Vf, the control module 201 may determine that the display panel is in a shutdown state.

As an example, the comparison sub-module 2010, as shown in FIG. 3, may include a comparator 2100, with an inverting terminal of the comparator 2100 connected to a constant voltage source Vh, a non-inverting terminal connected to the first voltage input terminal, and an output terminal connected to the conversion sub-module 2011. The constant voltage source Vh may be the preset voltage Vf. The voltage V1 of the first voltage input terminal may be compared with the constant voltage source Vh (the preset voltage Vf) through the comparator 2100, and the result of the comparison may be the output of the conversion sub-module 2011.

The conversion sub-module 2011 is connected to the comparison sub-module 2010 and the voltage reducing module 202 respectively. The conversion sub-module 2011 outputs a second voltage V2 or a third voltage V3 to the voltage reducing module 202 based on the comparison result of the comparison sub-module 2010.

In some embodiments, the second voltage V2 may be a high level VGH, the third voltage V3 may be a low level VGL. In other embodiments, the second voltage V2 may be a low level VGL and the third voltage V3 may be a high level VGH. In the embodiment of the present invention as illustrated and described with respect to FIG. 3, the second voltage V2 will be a high level VGH and the third voltage V3 will be a low level VGL.

When the voltage V1 of the first voltage input terminal is larger than the preset voltage Vf, it is determined that the display panel 103 is in the working state. The conversion sub-module 2011 outputs V3 (i.e., low level VGL, such as −8V), to the display panel 103 integrated with the GOA gate driving module 104 based on the above comparison result. In this instance, no processing is performed to the display panel 103 in the working state.

When the voltage V1 of the first voltage input terminal is smaller than the preset voltage Vf, the control module 201 may determine that the display panel 103 is in the shutdown state. The conversion sub-module 2011 outputs V2 (i.e., a high level VGH, such as 8V), to the display panel 103 integrated with the GOA gate driving module 104 based on the above comparison result. In this instance, the second voltage V2 is namely the off-voltage VOFF for charging the gates in rows of the display panel 103 when the GOA gate driving module 104 turns on the gates in rows of the display panel 103. When the conversion sub-module 2011 outputs the off-voltage VOFF to the gates in rows of the display panel 103, the voltage reducing module 202 will reduce the pulse current IOFF generated by the off-voltage VOFF, thus excessive current that may burn the particles of the Anisotropic Conductive Film can be avoided while turning on all the TFTs of the display panel 103. Charges accumulated on the liquid crystal capacitor CLC and the storage capacitor CS may be released so as to solve the afterimage phenomenon.

As illustrated in FIG. 3, the conversion sub-module 2011 may include a first transistor M1 and a second transistor M2. The gate of the first transistor M1 is connected to the comparison sub-module 2010, with the first pole connected to a second voltage input terminal and the second pole connected to the voltage reducing module 202. The gate of the second transistor M2 is connected to the comparison sub-module 2010, with the first pole connected to the voltage reducing module 202 and the second pole connected to a third voltage input terminal. In some embodiments, the first transistor M1 may be a P-type transistor and the second transistor M2 may be an N-type transistor.

Utilizing the transistors as illustrated in FIG. 3, an inverter can be constituted. When the comparison sub-module 2010 determines that the display panel 103 is in the working state, a high level may be inputted to the conversion sub-module 2011 and the gate of the N-type transistor M2 is turned on and voltage V3 (which is a low level VGL) is provided to the to the display panel 103 integrated with the GOA gate driving module 104. In this instance, no processing is performed to the display panel 103. When the comparison sub-module 2010 determines that the display panel 103 is in the shutdown state, a low level is inputted to the conversion sub-module 2011, the gate of the P-type transistor M1 is turned on, and voltage V2 (a high level VGH) of the second voltage input terminal is provided to the display panel 103 integrated with the GOA gate driving module 104. In this instance, the voltage V2 of the second voltage input terminal is the off-voltage VOFF for charging the gates in rows of the display panel 103 when the GOA gate driving module 104 turns on the gates in rows of the display panel 103. Consequently, all the TFTs of the display panel 103 can be turned on, so that the charges accumulated on the liquid crystal capacitor CLC and the storage capacitor CS are released, thereby solving the afterimage phenomenon.

Additional embodiments of the present invention provide for a display device comprising any display control unit as stated above, the display device having the same beneficial effect as the display control unit provided by the preceding embodiments of the present invention. Because the display control unit has been described in detail in the preceding embodiments, it will not be repeated here.

In some embodiments, the display device specifically may include a liquid crystal display device. For example, the display device may be any product or component with a display function, such as a liquid crystal monitor, a liquid crystal television, a digital photo frame, a mobile phone or a tablet computer, and the like.

In some embodiments, the present invention includes a display device comprising a display control unit. The display control unit is connected with the display panel. The display control unit includes: a GOA gate driving module integrated on a display panel, a control module, and a voltage reducing module. The voltage reducing module reduces the pulse current generated by the off-voltage when the control module outputs the off-voltage so as to eliminate the shutdown afterimage. Thus, the current flowing through the Anisotropic Conductive Film can be reduced during the process of eliminating the shutdown afterimage of the display device, thereby avoiding the conductive particles of the Anisotropic Conductive Film from being burnt by a relatively large current flowing through the Anisotropic Conductive Film.

As shown in FIG. 6, the display device may further include a voltage dividing circuit 30 connected to a fourth voltage input terminal, a ground terminal, and the first voltage input terminal respectively. The voltage dividing circuit 30 converts a voltage V4 of the fourth voltage input terminal into a voltage V1 of the first voltage input terminal.

It should be noted that the voltage V4 of the fourth voltage input terminal may be the power supply voltage of the display panel 103. The voltage V4 of the fourth voltage input terminal is divided by the above voltage dividing circuit 30 to obtain the voltage V1 of the first voltage input terminal. In this configuration, the voltage is compared to the preset voltage Vf of the comparison sub-module 2010. This configuration may be utilized when the value of the power supply voltage differs due to different types of the display device. For example, the power supply voltage of an existing tablet computer is generally 3.3V, the power supply voltage of a notebook PC is generally 5V, and the power supply voltage of a television is 12V. Generally, the preset voltage Vf can be set as 1.2v, i.e., the voltage of the constant voltage source of the comparator 2100 is 1.2v. Thus, the power supply voltage can be divided by the voltage dividing circuit 30, so as to enable it to be compared with the preset voltage Vf, thereby, enabling the control module 201 to determine the display state of the display device utilizing Vf and not the power supply voltage.

In order to achieve the voltage dividing effect, the above voltage dividing circuit 30, for example, may include a first voltage dividing resistor R1, with one terminal of the first voltage dividing resistor R1 connected to the fourth voltage input terminal and the other terminal thereof being connected to the first voltage input terminal; and a second voltage dividing resistor R2, with one terminal of the second voltage dividing resistor R2 connected to the first voltage input terminal, and the other terminal connected to the ground terminal.

The voltage dividing circuit 30 can divide the power supply voltage by the dividing function of the first voltage dividing resistor R1 and the second voltage dividing resistor R2 to enable the power supply voltage to be compared with the preset voltage Vf, thereby enabling the control module 201 to determine the display state of the display device. When the determination result is the shutdown state, the voltage reducing module 202 inputs the off-voltage VOFF (with a reduced pulse current IOFF generated by it) to the display panel 103 when the GOA gate driving module 104 turns on the gates in rows of the display panel 103 (to turn on all the TFTs), and the charges accumulated on the liquid crystal capacitor CLC and the storage capacitor CS are released. Releasing the charges, as described, avoids the conductive particles of the Anisotropic Conductive Film from being burnt by a relatively large current flowing through the Anisotropic Conductive Film and additionally eliminates the afterimage.

The above disclosure is only some specific implementations of the present invention; however, the protection scope of the present invention is not limited to this disclosure. Any variations or replacements that can be easily conceived of by a skilled person familiar with the present technical field should be within the protection scope of the present invention. Therefore, the protection scope of the present invention should be based on the protection scope of the attached claims and not limited by the present disclosure.

1-12. (canceled)

13. A display control unit comprising:
a GOA gate driving module integrated on a display panel;
a control module; and
a voltage reducing module;
wherein the control module is connected to a first voltage input terminal and the voltage reducing module respectively, for outputting an off-voltage to the display panel integrated with the GOA gate driving module based on a voltage of the first voltage input terminal, so as to charge at least one row of gate lines of the display panel under the control of the GOA gate driving module; and
wherein the voltage reducing module is connected to the control module and the GOA gate driving module respectively, for reducing the off voltage.

14. The display control unit of claim 1, wherein the voltage reducing module comprises:
a voltage reducing resistor with a resistance, wherein an input terminal of the voltage reducing resistor is connected to the control module, and an output terminal of the voltage reducing resistor is connected to the GOA gate driving module.

15. The display control unit of claim 2, where the resistance of the voltage reducing resistor is 20Ω-to 130 Ω.

16. The display control unit of claim 14, wherein the voltage reducing module further comprises:
a voltage reducing capacitor, wherein an input terminal of the voltage reducing capacitor is connected to the output terminal of the voltage reducing resistor, and an output terminal of the voltage reducing capacitor is connected to ground.

17. The display control unit according to claim 15, wherein the voltage reducing module further comprises:
a voltage reducing capacitor, wherein an input terminal of the voltage reducing capacitor is connected to the output terminal of the voltage reducing resistor, and an output terminal of the voltage reducing capacitor is connected to the ground.

18. The display control unit of claim 13, wherein the voltage reducing module comprises:
a voltage reducing diode, wherein an input terminal of the voltage reducing diode is connected to the control module, and an output terminal of the voltage reducing diode is connected to the GOA gate driving module.

19. The display control unit of claim 13, wherein the control module comprises:
a comparison sub-module; and
a conversion sub-module;
wherein the comparison sub-module is connected to the first voltage input terminal and the conversion sub-module respectively, for comparing a voltage of the first voltage input terminal with a preset voltage; and
wherein the conversion sub-module is connected to the comparison sub-module and the voltage reducing module respectively, for outputting one of a second voltage and a third voltage to the voltage reducing module based on a comparison result of the comparison sub-module.

20. The display control unit of claim 18, wherein the comparison sub-module comprises:
a comparator, wherein an inverting terminal of the comparator is connected to a constant voltage source, wherein a non-inverting terminal of the comparator is connected to the first voltage input terminal, and an output terminal of the comparator is connected to the conversion sub-module.

21. The display control unit of claim 18, wherein the conversion sub-module comprises:
a first transistor; and
a second transistor;
wherein a gate of the first transistor is connected to the comparison sub-module, wherein a first pole of the first transistor is connected to a second voltage input terminal, and wherein a second pole of the first transistor is connected to the voltage reducing module; and
wherein a gate of the second transistor is connected to the comparison sub-module, wherein a first pole of the second transistor is connected to the voltage reducing module, and wherein a second pole of the second transistor is connected to a third voltage input terminal.

22. The display control unit of claim 8, wherein the first transistor is a P-type transistor, and the second transistor is an N-type transistor.

23. A display device, comprising;
a display control unit, the display control unit comprising:
a GOA gate driving module integrated on a display panel, the display panel further comprising:
a control module and a voltage reducing module,
wherein the control module is connected to a first voltage input terminal and the voltage reducing module respectively, for outputting a off voltage to the display panel integrated with the GOA gate driving module based on a voltage of the first voltage input terminal to charge at least one row of gate lines of the display panel under the control of the GOA gate driving module; and
wherein the voltage reducing module is connected to the control module and the GOA gate driving module respectively, for reducing the off voltage.

24. The display device of claim 23, further comprising:
a voltage dividing circuit connected to a fourth voltage input terminal, a ground terminal, and the first voltage input terminal respectively, for converting a voltage of the fourth voltage input terminal into a voltage of the first voltage input terminal.

25. The display device according to claim 24, wherein the voltage dividing circuit comprises:
a first voltage dividing resistor, wherein one terminal of the first voltage dividing resistor is connected to the fourth voltage input terminal, and where the other terminal of the first voltage dividing resistor is connected to the first voltage input terminal; and
a second voltage dividing resistor, wherein one terminal of the second voltage dividing resistor is connected to the first voltage input terminal, and wherein the other terminal of the second voltage dividing resistor is connected to the ground terminal.
